(19) United States
(12) Patent Application Publication
(10) Pub. No.: US 2025/0163625 A1
(43) Pub. Date: May 22, 2025

(54) DEVICE AND METHOD FOR TREATING TEXTILES OR LEATHER

(71) Applicant: HS-TUMBLER GMBH, Quakenbrück (DE)

(72) Inventor: Bernhard HUKELMANN, Quakenbrück (DE)

(21) Appl. No.: 18/840,971

(22) PCT Filed: Feb. 24, 2023
(86) PCT No.: PCT/EP2023/054746

§ 371 Date: Aug. 23, 2024

(30) Foreign Application Priority Data
Feb. 25, 2022 (DE) 10 2022 201 993.8

(51) Int. Cl. D06B 3/20; C14C 15/00; D06B 5/26

(52) U.S. Cl. CPC D06B 3/205; C14C 15/00; D06B 5/26; D06B 2700/14

(57) ABSTRACT

Device for use in the treatment of textiles or leather with liquid, comprising a container having an inner wall with through-holes and surrounded by a spaced outer wall, with lids covering the terminal cross-sectional openings of the container, with a drive which drives the container along a trajectory curve to a reciprocating movement with a maximum acceleration of at least 20 m/s².

The present invention relates to a device suitable for use in the treatment of textiles or leather, and to a method of treating textiles or leather which can be carried out with the device. The method may be the washing and/or dyeing of textiles or leather. The textiles or leathers treated by the method may be garments, which may be finished or semi-finished, or uncut or web-shaped or cut textiles or leathers. The textiles may comprise cotton, wool, synthetic fiber, flax, a combination of at least two of these, and the leather may be raw or at least partially tanned. The method may include tanning and/or dyeing leather.

It is generally known to rotate a perforated drum rotatable about a horizontal axis in a container in order to treat textiles or leather in the drum with liquids which are in the container.

DE 10 2013 109 482 A1 describes a drum for the wet treatment of textiles, which is driven in rotation about a vertical axis and to which a line is attached, one end of which opens into an annular channel attached to the drum, which surrounds the drum radially, and the other end of which line discharges closer to the axis.

U.S. Pat. No. 1,981,453 A describes the conveying of liquid through textiles that lie against the wall of a rotating container, wherein the liquid is fed centrally into the container and, after passing through the textiles, exits through openings in the container wall.

WO 98/07057 A1 describes mixing by moving a container along a movement path with two areas of strong path curvature or two reversal points.

DE 10 2018 215 084 A1 describes the reciprocating movement of a container with the components of the mass along two axes, each with a different frequency, for the production of a mass that has a continuous homogeneous phase.

The object of the invention is to provide an alternative device and a method for treating textiles or leather which can be carried out with it and which can be carried out with a small volume of liquid.

The invention achieves the object by the features of the claims and in particular with a device for use in the treatment of textiles or leather with liquid, wherein the device has or consists of
a container with an optional inner wall which has through-holes and is surrounded by a spaced outer wall, the inner wall preferably being firmly connected to the outer wall, with lids which cover the terminal cross-sectional openings of the container, optionally with at least one movable line connected to the container, which is connected to at least one of the lids, optionally to the intermediate space formed between the inner wall and the outer wall spaced therefrom,
a drive which is set up to drive the container along a trajectory curve for a reciprocating movement, the plane in which the trajectory curve extends and in which the container is moved preferably lying parallel to the cross-section of the container,
and the drive is set up to move the container along the trajectory curve with a maximum acceleration of at least 20 m/s², preferably at least 30 m/s² or at least 50 m/s² or at least 100 m/s², e.g. up to 600 m/s² or up to 500 m/s² in each case, the device optionally being set up not to rotate the container during the movement along the trajectory curves, in particular not to rotate it about an axis perpendicular to the plane of the trajectory curves,
wherein optionally the device is arranged, if the drive for movement along the trajectory curve does not move the container, to drive the container, e.g. by a second drive, to rotate about an axis perpendicular to the plane of the trajectory curve.

The inner wall is preferably cylindrical, with the cross-section parallel to the plane of the trajectory curves, optionally the inner wall has a hexagonal, octagonal, decagonal or dodecagonal or polygonal cross-section. The inner wall spans the interior of the container. The terminal cross-sectional openings of the container interior, preferably including the terminal cross-sectional openings of the outer wall, are closed with lids that preferably lie parallel to the plane of the cross-section that is spanned by the inner wall.

Preferably, the spacing at which the outer wall surrounds the inner wall is 1 to 20 mm, preferably 1 to 10 mm or up to 5 mm, e.g. 2 to 4 mm. The small spacing between the inner wall and the outer wall results in a small dead volume into which liquid can enter through the through-holes in the inner wall. From this dead volume, which is limited by the spacing between the inner and outer walls, liquid can be drawn off through an optional pipe connected to it, the container can be evacuated, or liquid or air, in particular air heated to e.g. 50 to 90° C., can be conveyed into the container through the pipe.

Preferably, the cross-section that is spanned by the inner wall has a diameter that is 0.5 times to 2 times the extension along the longitudinal axis, which is perpendicular to the cross-section.

Textiles and leather are also referred to herein as fabrics.

The cross-section, when reciprocating along a trajectory curve, for example by moving reciprocatingly along at least two axes which are at an angle to each other and in the plane of the cross-section of the container, leads to a relative movement of the fabrics filled into the container against the container wall. It is assumed that the intensive and effective penetration of the fabrics with liquid during the process is due to the fact that the movement of the container accelerates the fabrics contained therein with more than 1×g (acceleration due to gravity) relative to the inner wall.

The container is driven for reciprocating movement along at least one trajectory curve which can be generated by superimposing the reciprocating movement along at least two axes which lie at an angle to one another, wherein preferably two of the axes lying in the plane of the cross-section of the container, the reciprocating movement along each axis taking place at different frequencies and/or with a phase offset. The trajectory curve can be generated by superimposing the reciprocating movement along two or three axes at different frequencies and/or with phase offset and has a sequence of path segments, at least one of which, preferably each, comprises or consists of exactly one complete reciprocating movement along the axis along which the reciprocating movement takes place at the lower frequency, wherein the superimposed reciprocating movements of the higher frequency or the same frequency are comprised, in each case optionally with phase offset, along the other axis or axes. Therein, the lower frequency of the complete reciprocating movement forms the frequency of the sequence of path segments. For each path segment, a frequency ratio of the reciprocating movement along two axes of at maximum 1:20 or maximum 1:15 or at maximum 1:10, at maximum 1:4 or at maximum 1:3 is preferred, more preferably between 1:1 and 1:2, even more preferably greater than 1:1 to 1:2 or up to 1:1.5, e.g. with a frequency ratio of 1:1.001 to 1:2 or up to 1:1.5.

In the case of a trajectory curve that can be generated by superimposing the reciprocating movements along two axes at different frequencies and/or with a phase offset, the axes preferably lie in the plane of the cross-section of the container. In the case of a trajectory curve that is formed by superimposing the reciprocating movement along three axes, two of the axes preferably lie in the cross-sectional plane of the container and the third axis is at an angle to this cross-sectional plane. Therein, the lowest frequency of the complete reciprocating movement along one of the three axes is the frequency of the sequence of the path segments. In general, the linear axes of movement are preferably at right angles to each other.

In general, the device is set up to drive the container along a trajectory curve which is formed by superimposing the reciprocating movement of at least two superimposed linear axes which are at an angle to one another, wherein the reciprocating movement along the linear axes take place at different frequencies and/or with a phase offset. The linear axes, along which the superimposed reciprocating movements take place at different frequencies and/or with phase offset, form the trajectory curve along which the reciprocating movement of the container takes place, for which the device is set up.

By moving the container along the trajectory curve, the device is set up to accelerate the fabrics relative to the container so that the fabrics contained in the container come into intensive contact with liquid or air due to the acceleration against the container wall.

Since the trajectory curve can be adjusted or predetermined by the different frequencies and/or the phase offset of the superimposed movements along the linear axes, the device is set up to move the container reciprocating along the trajectory curve and to move the fabrics in it relative to the container.

The trajectory curve, which can be adjusted or predetermined by the different frequencies and/or by the phase offset of the superimposed movements along at least two linear axes, accelerates the fabrics relative to the container. The reciprocating movement of the container drives the fabrics and the liquid contained in the container to move against the inner wall of the container.

Optionally, at least during the movement along the trajectory curve, the container is not rotationally driven, and is further preferably not or not completely rotatable, e.g. guided rotatably by a maximum of 30° or by a maximum of 20° or 10° about its longitudinal axis. Generally preferred, the container is driven exclusively for a reciprocating movement along a trajectory curve, optionally additionally drivable for rotation if the container is not driven along the trajectory curve, in particular optionally exclusively driven to rotation with a time offset to the reciprocating movement along the trajectory curve. Optionally, the container is freely rotatable about an axis perpendicular to the plane of the trajectory curve and is not rotationally driven about its longitudinal axis.

The angle of incidence and angle of projection of the fabrics against the container wall can be determined by the trajectory curve. In addition, the device is optionally set up to move the container along the trajectory curve with adjustable or predetermined acceleration and speed. Because the device is set up for an adjustable or predetermined trajectory curve and/or an adjustable or predetermined acceleration and/or an adjustable or predetermined speed along the trajectory curve of the reciprocating movement of the container, the fabrics and liquid contained in the container are driven with adjustable or predetermined maximum acceleration and/or adjustable or predetermined speed relative to the container and allows a predetermined or continuous adaptation of the process to the fabrics to be treated.

In general, a trajectory curve can be formed by at least two superimposed individual oscillations; preferably, a trajectory curve resembles the trajectory curve that can be generated by superimposing reciprocating movements along at least two linear axes of movement at different frequencies and/or by phase offset. A reciprocating movement along a trajectory curve that resembles the reciprocating movement along linear axes of movement that are superimposed on one another have different frequencies and/or a phase offset to one another. Optionally, the trajectory curve can be a circular path or exclude it.

The difference in frequencies can, for example, be at least 0.01 Hz and/or 0.01% to 900%. The phase offset of the reciprocating movements along the linear axes can be e.g. from 0.01° to 180°, preferably 1 to 179° of 360°, which corresponds to a complete reciprocating movement. Here, 0.01 to 180° of a complete reciprocating movement of 360° is equal to 0.0028% to 50% of a complete reciprocating movement, 1 to 179° of 360° is equal to 0.28% to 49.7% of a complete reciprocating movement.

Therein, the linear axes of movement are perpendicular or at a different angle to each other, for example, e.g. 5° to 85°, in particular in the plane of the cross-section of the container or perpendicular to a longitudinal axis of the container. Optionally, the trajectory curve contains path segments with at least one straight section, the end of which is, for example, an apex at which the fabrics are accelerated relative to the container wall.

For setting different frequencies and/or a phase offset of the superimposed reciprocating movements along at least two linear movement axes, these reciprocating movements can be coupled together by a transmission or a link guide and driven by a motor. Therein, a transmission driven by a motor, which adjusts the reciprocating movement along the trajectory curve, can have a fixed transmission ratio between the superimposed movements along each axis, or an adjustable transmission ratio, e.g. a continuously or incrementally shiftable transmission. Optionally, the transmission can be slip-loaded, e.g. have a belt drive or be a friction gearbox.

The output speed of the transmission, which drives the reciprocating movement of the container, is preferably at least 0.5 Hz, more preferably at least 2.5 Hz, at least 5 Hz, e.g. up to 10 Hz, e.g. 4 Hz to 40 Hz, up to 30 Hz, up to 20 Hz or up to 10 Hz. Therein, the output speed of the transmission is equal to the frequency of the reciprocating movement.

Alternatively, the reciprocating movement along each of the linear axes of motion may be driven by a separate motor, wherein for the purposes of the invention, the lower output speed is the frequency of the reciprocating movement and forms the frequency of the sequence of path segments. In any embodiment, the speed of each drive motor may be controlled, fixed or variable over the duration of the process.

The device allows the trajectory curve to accelerate the fabrics in a defined direction to a specific location on the inside wall of the container. The geometry of the container in conjunction with the trajectory curve can support the washing process so that the trajectory curve can be adjusted depending on the shape and size of the container cross-section.

Optionally, the device is set up to change the trajectory curve of the reciprocating movement and/or the acceleration and/or speed of the reciprocating movement during the process, for example in a first phase to set the reciprocating movement along a first trajectory curve and with a first acceleration and speed and to set the reciprocating movement in a subsequent second phase along a changed trajectory curve and/or changed acceleration and/or speed.

Further optionally is that the reciprocating movement is a linear reciprocating movement in a first phase and a reciprocating movement along merging trajectory curves in a second phase. The trajectory curve can, for example, be determined by a transmission that drives the movement of the container.

The device allows a predetermined or dynamically variable and directed acceleration of the fabrics relative to the container by adjusting the trajectory curve and acceleration of the reciprocating movement of the container.

In an embodiment, in which the container can be driven in a controlled manner in a first phase for a linear reciprocating movement, the device is set up to move fabrics and optionally liquid perpendicularly against the container wall with a controllable acceleration which is significantly greater than the acceleration due to gravity and is therefore essentially independent of the acceleration due to gravity, e.g. with a maximum acceleration of at least 15 m/s², preferably 25 m/s², preferably at least 50 m/s² or at least 100 m/s² or at least 200 m/s² or at least 350 m/s², e.g. up to 500 m/s² in each case.

In general, the device can be set up to accelerate the container with a maximum acceleration of at least 15 m/s², 20 m/s², or at least 25 m/s², e.g. at least 50 m/s², preferably up to 100 m/s², preferably 200 m/s², e.g. in each case up to 300 m/s² or 450 m/s², up to 260 m/s² or up to 250 m/s² along the trajectory curve, e.g. at an apex of the trajectory curve.

The container is preferably designed to be driven to a reciprocating movement with a maximum acceleration of at least 0.5 m/s² or at least 1 m/s² or at least 2 m/s², at least 3.5 m/s², preferably at least 60 m/s², more preferably at least 100 m/s², at least 150 m/s², at least 160 m/s², at least 200 m/s², e.g. up to 300 m/s² in each case, or 450 m/s², up to 260 m/s² or up to 250 m/s² along each of two axes. Generally preferably, the container is driven in combination with the acceleration to an average speed of at least 0.5 m/s, preferably at least 2 m/s, more preferably at least 3.5 m/s, e.g. up to 10 m/s or up to 20 m/s or up to 6 m/s, e.g. 3 to 4 m/s, in each case along one of the axes, preferably along each axis. Therein, the path of the movement along at least one axis, preferably along each axis, is e.g. 0.1 cm to 24 cm.

The container can, for example, be driven to a reciprocating movement along each axis which extends for a distance of at least 1 mm or 2.5 mm, at least 1 cm, preferably at least 2 cm or at least 5 cm, at least 10 cm or at least 15 cm, e.g. up to 100 cm, up to 50 cm, up to 30 cm or up to 20 cm in each case. Further preferably, the reciprocating movement of the container is harmonious. The reciprocating movement of the container can be linear in a first phase, generally the trajectory curve is non-linear and can be e.g. sinusoidal, triangular, loop-shaped or pretzel-shaped or arcuate, e.g. running along a so-called Lissajous figure or hypocycloid, which preferably lies in the plane, or is two-dimensional, optionally three-dimensional. Preferably, the reciprocating movement is linear in a first phase and in a second phase along at least two non-linear path segments, each containing at least one vertex, to form a trajectory curve. This is because a nonlinear trajectory curve, e.g. a movement along a trajectory curve whose path segments each have at least one apex, generally promotes an impact of fabrics perpendicular to the inner wall of the container, as well as optionally a uniform and intensive rolling or sliding of the fabrics, at least in sections, along the inner wall, which is optionally structured.

Preferably, the reciprocating movement comprises the reciprocating movement along trajectory curves which merge into one another and which comprise at least two, preferably at least three, more preferably at least four different trajectory curves which merge into one another in a sequence-controlled manner. Each of the movement axes along which the movements are superimposed to form a trajectory curve can be linear or arcuate, so that the non-linear movement of the container is generated from the superimposition of the movements along two movement axes. Therein, the container wall is the circumferentially closed wall of the container, which extends around a longitudinal axis and between opposing end cross-sections or lids attached thereto. The container has an optionally circular cross-section that extends about a longitudinal axis and is spanned by the container wall. Generally preferred, the terminal cross-sectional openings of the container are each covered by a lid, at least one of which optionally has a through-opening.

It is generally preferred that the trajectory curve has at least one, preferably at least two or at least three path segments, each of which has at least one vertex at which they change their direction by at least 90°, more preferably by at least 120°, even more preferably by at least 180°. It is generally preferred that at least one path segment has an apex in which the direction of the path segment changes by at least 90°, more preferably by at least 120°, even more preferably by at least 180° or at least 210°, e.g. within a maximum of 24.5%, a maximum of 24%, a maximum of 23%, a maximum of 22%, a maximum of 21%, a maximum of 20%, a maximum of 15% or a maximum of 10%, preferably a maximum of 5% or a maximum of 3%, a maximum of 2% or a maximum of 1% of the length of a path segment. This is because an apex of the trajectory curve leads to a strong relative acceleration of the fabric against the container. The apices and intermediate sections of a path segment are determined by the frequency difference and/or the phase position of the superimposed reciprocating movements along at least two axes. In general, the device can be set up to change the frequency difference and/or the phase position during the reciprocating movement.

The control of the drive of the container is optionally controlled depending on the signal of a sensor, preferably an acoustic sensor, which picks up vibrations, in particular noises of the container during the reciprocating movement, in particular during the first and/or during the second phase. The acoustic sensor can, for example, be attached to the outer surface of the container or fixed at a distance from the container in a position past which the reciprocating movement of the container passes. Preferably, the acoustic sensor is fixed at a small distance, e.g. from 0.5 to 5 cm, from the apex of the reciprocating motion, e.g. fixed to a frame relative to which the container is moved along the trajectory curve. The acoustic sensor can be a vibration sensor, e.g. a microphone. In this embodiment, the control of the reciprocating movement can be set up so that, when the signal emitted by the acoustic sensor changes for a predetermined deviation within a predetermined time of the reciprocating movement, and/or when reaching a pre-determined signal emitted by the sensor, the reciprocating movement is carried out with a changed speed and/or with a changed phase offset and/or to control it from a linear movement into a trajectory curve, in particular to control it from a first phase to a second phase of the reciprocating movement.

The sensor can also be an optical sensor attached to the container, e.g. a turbidity sensor.

Optionally, a device for generating electrical voltage is attached to the container, in particular a device with a magnet and a coil arranged to move relative to the magnet, which are set up to generate electrical voltage when moving relative to each other. This device is preferably connected to a transmitter attached to the container by means of an electrical cable in order to apply electrical voltage to the transmitter. The transmitter is preferably connected to at least one of the sensors by means of a data line in order to receive sensor signals. The transmitter is set up, for example, to transmit received sensor signals. Furthermore, the sensor can be connected to the device for generating electrical voltage by means of an electrical line. In this embodiment, the device is set up so that a sensor and a transmitter attached to the container can be energized by the device for generating electrical voltage as soon as the container is moved along the trajectory curve. Accordingly, the device may be formed without an electrical cable extending between a frame relative to which the container is moved and the container.

In general, the path of movement is along at least one axis, preferably along each axis, e.g. 5 cm to 24 cm.

The inner wall and the outer wall, different or identical, may consists of metal, preferably stainless steel, of plastic or ceramic.

Optionally, a pipe is connected to the container for supplying air, preferably at a temperature of 30 to 90° C. or up to 60° C., in order to dry fabrics in the container while the container is moved along merging trajectory curves, or while the container is moved reciprocating linearly. An outlet pipe, which can be the pipe connected to the space between the inner and outer wall, for example, is preferably connected to the container in order to remove moist air from the container.

The through-holes of the inner wall can be round holes or elongated holes that extend parallel or perpendicular to the cross-section of the inner chamber, or that extend at an angle of >0° to <90° to the cross-section of the inner volume. Optionally, additionally or alternatively, the through-holes may extend along the radial or at an angle of 10° to 45° to the radial extending from the longitudinal axis of the cross-section spanned by the inner wall. Optionally, the through-holes have a constant cross-section or a cross-section that widens with increasing distance from the longitudinal axis. Generally preferred, the through-holes have a chamfer, preferably arcuate, to avoid sharp edges adjacent to the cross-section. In a simple embodiment, the inner wall can be a grid, the webs of which form the through-holes between them.

The inner wall can be connected to the outer wall by supports that extend across the interspace between the inner and outer walls. Therein, the inner wall can be connected to the outer wall by the inner wall resting against supports that extend across the spacing between the inner wall and the outer wall. Supports between the inner and outer wall can be formed in one piece with the outer wall or with the inner wall or be connected to one or both of these, e.g. soldered, welded or glued. Alternatively, supports can only be arranged having positive fit between the inner and outer walls, e.g. as at least one separate element. The supports can be designed as webs which extend parallel to the cross-section of the container inner volume, e.g. annular or angular like the container inner volume, or as webs which extend at an angle to the cross-section of the container inner volume, e.g. spirally, preferably as webs which extend perpendicular to the cross-section of the container inner volume, so that channels are formed between them which discharge with a spacing in front of at least one, preferably both, terminal cross-sectional surfaces of the interspace between the inner and outer walls. Furthermore, the supports can be formed by a grid in which a portion of the webs has a lower height for the passage of liquid and air than the spacing between the inner and outer walls. In general, supports, especially in the form of webs between them form the dead volume, through which liquid, optionally air, can be supplied and/or discharged separately from the laundry, e.g. during vacuuming or drying, in particular by means of lines connected to the interspace between the inner and outer walls.

The process carried out using the device has the advantage that during the movement of the container along merging trajectory curves, in particular at high acceleration maxima of fabrics relative to the container or to the inner wall, the fabrics contained therein are intensively contacted with the liquid, e.g. are milled, and can roll against the inner wall, so that the fabrics preferably rub against each other and rub less against the inner wall of the container.

In addition, fine air bubbles are created which accelerate the cleaning process when rinsing the fibers.

The invention will now be described in more detail by means of an example with reference to the figures, which schematically show in

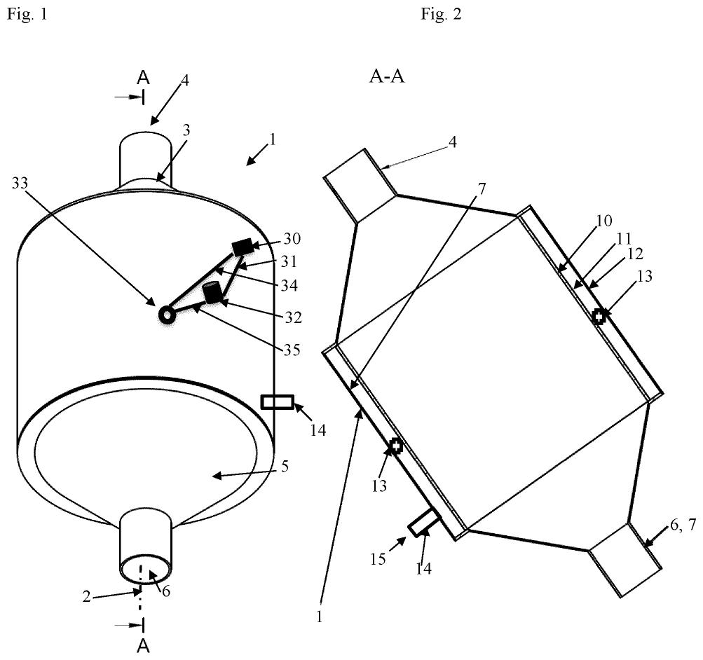

FIG. 1 an exemplary container and

FIG. 2 the container of FIG. 1 in cross-section A-A.

In the figures, identical reference numerals denote elements with the same function.

FIG. 1 shows a container 1 which, as generally preferred, has a circular cross-section, with a first access opening 4 attached to a first lid 3 along the longitudinal axis 2 and a second access opening 6 attached to the opposite second lid 5 along the longitudinal axis 2. Lines can be connected to the access openings 4, 6, e.g. for supply air and exhaust air during drying. The first lid 3 and the second lid 5 each cover a terminal cross-section of the container 1. These lids 3, 5 herein run in a funnel shape, alternatively in the plane of the container cross-section, from the container 1 to one of the access openings 4, 6. The container 1 can alternatively have only one access opening 4, 6, which is provided in one of the lids 3, 5, so that the filling and emptying of the container 1 can take place through only one common access opening 4, 6. Preferably, one of the lids 3, 5 is detachably attached to the container 1 so that textiles or leather can be filled into the container and removed from it.

A sensor 30, which is attached to the container 1, is connected by means of an electrical line 31 to a device 32 attached to the container 1 for generating electrical voltage, which has a magnet that can move relative to a coil. A transmitter 33 is connected to the sensor 30 by means of a data line 34 and to the device 32 for generating electrical voltage by means of an electrical line 35.

The longitudinal section through the container 1 shown in FIG. 2 shows the through-holes 10 in the inner wall 11. The inner wall 11 is surrounded by the outer wall 12. The outer wall 12 is spaced from the inner wall 11 by the supports 13. The connection 14 opens into the interspace between the inner wall 11 and outer wall 12, e.g. to introduce liquid or to draw off liquid or air.

### Example: Treatment of Fabrics

As an example of fabrics, 5 kg lengths of cotton fabric were filled into a container with a cylindrical inner cross-section with a diameter of 50 cm and a length of 80 cm. The inner wall was made of stainless steel sheet and had chamfered holes 2 mm in diameter, each 2 cm apart, the outer wall was a cylinder made of stainless steel, spaced 3 mm apart, with supports in between formed by plastic bars pushed into the interspace roughly parallel to the longitudinal axis of the container.

The terminal cross-sectional areas were closed with clamped lids, one of which had a connected hose for supplying water and detergent. On the outer wall there was a connecting piece with a hose connected to it, which was connected to the interspace between the inner and outer walls. Through the hose connected to the lid, 2 L of water with detergent dispersed in it was poured into the container. Subsequently, the container was moved reciprocating for 10 to 30 min along trajectory curves, each 30 cm long, whereby the trajectory curves were generated by reciprocating movements along a first linear axis at 4 Hz and along a second linear axis, offset by 90° to the first axis, at 5 Hz.

In another experiment, instead of detergent dye was added to the water to color the fabric. Before the water was added, the container was vacuumed using a vacuum pump connected to the hose.

Subsequently, the reciprocating movement was stopped and liquid was drawn off through the hose, optionally the container was moved along a circular path so that the laundry rolled off the inner wall and liquid was pressed out of the fabric into the interspace.

Clear water was then poured into the container twice and, each time moving the container in a circular path, water was drawn off through the hose to rinse the fabric in two steps.

### REFERENCE NUMBERS

1 container
2 longitudinal axis
3 first lid
4 access opening
5 second lid
6 second access opening
10 through-holes
11 inner wall
12 exterior wall
13 supports
14 connection
15 line
30 sensor
31 electrical cable
32 device for generating electrical voltage
33 transmitter
34 data line
35 electrical cable

1. A device for the treatment of textiles or leather with liquid, comprising:
a container comprising an inner wall;
through-holes in the inner wall;
a spaced outer wall surrounding the inner wall;
lids configured to cover terminal cross-sectional openings of the container;
a drive configured to drive the container in a plane along a trajectory curve comprising a sequence of path segments, wherein the sequence of path segments comprises a superimposition of reciprocating movement along at least two axes with different frequencies, wherein the path segments each comprise exactly one complete reciprocating movement along the axis along which the reciprocating movement takes place with a lower one of the different frequencies and each comprises at least one apex defining a direction change of at least 90° within a maximum of 24.5% of the length of a path segment.

2. The device according to claim 1, comprising a line connected to an interspace between the inner wall and the outer wall.

3. The device according to claim 1, wherein the path segments comprises an apex defining a direction change of at least 120° within a maximum of 10% of the length of a path segment.

4. The device according to claim 1, wherein a plane in which the trajectory curve extends and in which the container is moved lies parallel to a cross-section of the container.

5. The device according to claim 1, comprising a second drive configured to rotate the container about a longitudinal axis perpendicular to a plane of the trajectory curves.

6. The device according to claim 5, wherein the second drive is configured to drive the container to rotate about its longitudinal axis only when the drive for movement along trajectory curves is not moving the container.

7. The device according to claim 1, wherein the container is configured to avoid rotation.

8. The device according to claim 1, wherein the container is freely rotatable.

9. The device according to a difference in frequencies between the different frequencies is at least 0.01 Hz and 0.01% to 900%, and wherein the reciprocating movement comprises a phase offset that is 0.0028% to 50% of a complete reciprocating movement.

10. The device according to claim 1, wherein the terminal cross-sectional openings of the container and terminal cross-sectional openings of the outer wall are closed with lids that lie parallel to a plane of the cross-section that is spanned by the inner wall.

11. The device according to claim 1, wherein the drive is configured to drive the container with a maximum acceleration of at least 3.5 m/s².

12. The device according to claim 2, comprising an air supply line connected to the container, wherein an outlet line is formed by the line connected to the interspace.

13. The device according to comprising supports which extending over an interspace between the inner and outer walls and connecting the inner wall to an outer wall.

14. The device according to claim 13, wherein the supports are arranged having only positive fit as at least one separate element between the inner and outer walls.

15. The device according to claim 1, where the drive comprises a transmission that is at least a belt drive driven by exactly one motor and/or a friction gear driven by exactly one motor.

16. The device according to claim 1, comprising a sensor connected to a controller configured to control the frequency of the reciprocating movement and/or the acceleration of the container during the reciprocating movement in dependence upon the signal from the sensor.

17. The device according to claim 1, comprising a generator attached to the container comprising a magnet and a coil arranged movably relative to the magnet, the generator being connected via an electrical line to a transmitter attached to the container.

18. The device according to claim 16, wherein the sensor comprises an acoustic sensor attached to the container or fixed on a frame on which the container is guided for the reciprocating movement at a distance from an inflection point of the trajectory curve.

19. The device according to claim 17, wherein the sensor is attached to the container and is connected to the transmitter.

20. (canceled)

21. A process for treating textiles or leather with liquid, comprising the filling textiles or leather into an inner volume spanned by a container of the device of claim 1, filling liquid into the container through a line connected to the container, and reciprocatingly moving the container along the trajectory curve.

22. (canceled)
